(19) United States
(12) Patent Application Publication
(10) Pub. No.: US 2012/0094795 A1
(43) Pub. Date: Apr. 19, 2012

(54) V-SHAPED TRANSMISSION BELT AND BELT WHEEL AND METHOD OF USE

(75) Inventor: Jinfang WANG, Hangzhou (CN)

(73) Assignee: ZHEJIANG KINGLAND TRANSMISSION INDUSTRY CO., LTD., Hangzhou (CN)

(21) Appl. No.: 13/336,588

(22) Filed: Dec. 23, 2011

Related U.S. Application Data
(63) Continuation-in-part of application No. PCT/CN2009/073181, filed on Aug. 11, 2009.

(30) Foreign Application Priority Data
Jun. 23, 2009 (CN) 200910303564.1

(51) Int. Cl. F16H 7/02; F16H 55/17; F16G 1/28

(52) U.S. Cl. 474/153; 474/205; 474/152

(57) ABSTRACT

The V-shaped transmission belt has concave and convex teeth on the inner diameter surface which are designed according to the engaging transmission principle. For the belt wheel with a V-shaped groove, the concave tooth on the bottom of the V-shaped groove comprises an engaging transmission section designed according to the engaging transmission principle, and a rolling friction transmission section disposed symmetrically on two sides of the engaging transmission section.

### BACKGROUND OF THE INVENTION

1. Field of the Invention

The present invention relates to the power transmission field, and more particularly, to a V-shaped transmission belt and a belt wheel with a V-shaped groove.

2. Description of the Related Art

In the prior art, the transmission between a V-shaped transmission belt and a belt wheel totally depends on the friction of a V surface. When a small belt wheel works as a driving wheel and a big belt wheel works as a driven wheel, for deceleration, the ratio of the wheel diameter of the big wheel to the small wheel is very large, and the wrap angle of the big belt wheel is much larger than that of the small belt wheel, and thus resulting in the common slip behavior of the small belt wheel, especially in the weather of rain or snow. Take an oil pump in oil fields for example, the slip not only aggravates wearing of the belt, but also makes the production operation intermittent and idling for a long period, and thus the production efficiency decreases significantly and even the production stops. Enlarging the small belt wheel and increasing the V surface area can increase the friction; however, the cost is very high and uneconomical for uncommon slip behavior.

A synchronized belt transmission is a precise motion. The rotation speed ratio of two belt wheels is constant and not allowed to change. Using the synchronized belt can solve the slip problem effectively, but both wheels in the transmission by the synchronized belt are toothed, the cost of toothed wheels is very high, and besides there are drawbacks of “tooth gnawing” problem and a short lifetime, and thus is also uneconomical for solving the unusual slip problem.

### SUMMARY OF THE INVENTION

The present invention is a composite transmission system of V-shaped belt created for overcoming deficiency of various transmission methods in the transmission field. The present invention provides a V-shaped belt and a cooperating belt wheel to prevent slip behavior effectively, raise the transmission efficiency, and have small belt deformation and a long belt lifetime. The difficult problem that slip and idle behaviors easily occur in a conventional belt transmission in the prior art is solved.

Another technical issue to be solved by the present invention is to provide a composite transmission method using slipping friction transmission, engaging transmission, and rolling friction transmission when overloading.

It is an object of the present invention to provide a V-shaped transmission belt cooperating with a belt wheel with a V-shaped wheel groove, wherein, a convex portion and a concave portion designed according to an engaging transmission principle are disposed on the inner diameter surface of the transmission belt. The shape and size of the concave portion and the convex portion are the same. The convex portion engages with an engaging transmission section on groove bottom of the concave portion on the belt wheel. A gap is formed between the concave portion and the convex portion on the belt wheel.

Two side surfaces of the V-shaped transmission belt contact with two side walls of the wheel groove to generate a friction force. When operating normally, the shape of a convex portion on the V-shaped transmission belt is the same as the shape of a concaved engaging section on the belt wheel. The convex portion on the inner diameter surface of the V-shaped transmission belt engages with the concaved engaging section on the belt wheel for transmission. When the loading suddenly changes or is overloaded, the convex portion of the inner diameter surface of the V-shaped transmission belt have a rolling friction or slipping friction with a curved section on two sides of the concaved engaging section on the belt wheel.

It is preferred that a gap h is formed between the top of the convex portion of said small belt wheel and the groove bottom of the concave portion of said V-shaped belt. The radius of the convex portion of said V-shaped belt is R, and 0.2 mm≦h<R. The gap size is improved according to the belt wheel size, mainly to ensure a sufficient heat-dissipating gap is reserved and to raise the heat-dissipating efficiency.

It is preferred that the concave and convex portions of said transmission belt are spaced at intervals in sequence and distributed uniformly. The concave and convex portions of the transmission belt consist of a concave toothed part and a convex toothed part, and the concave and convex portions on the transmission belt connect with each other and are distributed uniformly.

It is preferred that the concave and convex portions of said transmission belt are arc gear, or are selected from a group consisting of an involute gear, an elliptic gear, a hyperbolic gear, a parabolic gear and a cycloidal gear. It is preferred that the concave and convex portions of the transmission belt are arc gear. The arc gear helps achieve the best engaging transmission efficiency.

It is preferred that a belt structure of said transmission belt comprises a cotton rope layer. The top of the cotton rope layer is composed of a buffering glue layer, a curtain cloth layer, a buffering glue layer, a twilled cloth layer, a buffering glue layer and a twilled cloth layer adhered to each other in sequence. The bottom of said cotton rope layer is composed of a buffering glue layer, a fiber glue layer, a buffering glue layer, a curtain cloth layer, a fiber glue layer and a buffering glue layer adhered to each other in sequence. An elastic cloth layer is disposed on the surface of the concave and convex portions of said transmission belt. This design can increase rigidity of the transmission belt and prevent the transmission belt from breaking.

It is preferred that the transmission belt is a multi-row joined combination. The inner bottom surface of the V-shaped belt is divided into 1 to 100 parallel sub-V-shaped belts along the axial direction. The number of the multi-row joined combination on the transmission belt changes according to usage demands or shape sizes.

It is another object of the present invention to provide a belt wheel cooperating with a V-shaped transmission belt. Concave and convex portions are disposed along circumference and at bottom of a V-shaped wheel groove. A curve designed according to an engaging transmission principle is disposed on the bottom of the concave portion as an engaging transmission section. A curved section with a large curvature is disposed symmetrically on two sides of the engaging section as a rolling friction transmission section. The curvature radius of the rolling friction transmission section is greater than the curvature radius of the engaging transmission section. The curvature radius of the convex portion is smaller than the curvature radius of the engaging transmission section.

Two side walls of the V-shaped wheel groove of the belt wheel contact with two side surfaces of the V-shaped transmission belt to generate a friction force. When operating normally, the concaved engaging section on the belt wheel engages with the convex portion on the inner diameter surface of the V-shaped transmission belt for transmission. When the loading changes suddenly or is overloaded, the curved section with the large curvature disposed on two sides of the concaved engaging section on the belt wheel has a rolling friction with the convex portion of the inner diameter surface of the V-shaped transmission belt.

The toothed portions of the concave and convex portions on the belt wheel are connected by curves of three curvature radii. The curvature radius of the convex portion on the belt wheel is the smallest. The concave portion and the convex portion on the V-shaped belt are the same, and both are designed according to the engaging principle, that is to say, the curvature radius of the convex portion on the belt wheel is smaller than the curvature radius of the concave portion on the belt wheel, so that there is a gap reserved between the convex portion of the belt wheel and the concave portion on the V-shaped belt for heat dissipation and for reducing bending and constraint of the belt. The curvature radius of the rolling friction transmission section is the largest, for ensuring the convex portion of the V-shaped belt with elastic deformation can enter the concave portion of the belt wheel and generate engaging transmission without tearing the belt tooth when the belt wheel contacts with the V-shaped belt.

The belt wheel of the V-shaped belt as designed above can cooperate with the V-shaped belt very well. Two side surfaces of the belt and two side surface of the belt wheel are in a slipping friction transmission status. The convex portion of the V-shaped belt and the belt wheel are in an engaging transmission status at the engaging section. When the transmission is overloaded or the loading suddenly changes, the V-shaped belt and the small belt wheel are in the rolling friction transmission status again, and even the belt tooth can climb the convex portion of the wheel tooth to the maximum degree and further reenter the engaging section for engaging transmission through the rolling entry section. Such composite transmission system including slipping friction transmission, engaging transmission and rolling friction transmission solves the slipping issue of the small belt wheel cleverly, and at the same time cleverly solves the difficult problem that the engaging transmission cannot perform overload protection. Because the belt tooth and the wheel tooth operate by rolling, the conventional slipping friction is changed into the rolling friction, so as the friction coefficient is greatly reduced, the belt operating lifetime is greatly increased, and the friction power loss is reduced such that the belt has the energy saving effect.

It is preferred that the curve height of said engaging section is smaller than the belt tooth radius of the belt engaging with the belt wheel. The engaging depth of them is designed to be smaller than the belt tooth radius. However, when the loading changes suddenly or is overloaded, the belt tooth is allowed to easily withdraw from engaging transmission at the rolling friction transmission section in the concave portion of the belt wheel and enter the rolling friction transmission status, and this rolling friction transmission proceeds by being constrained by the curve designed between the engaging transmission section of the belt wheel and the convex portion of the V-shaped belt. Therefore, the design of the present invention not only ensures the accuracy of engaging transmission, but also implements protection to the belt when overloading or the loading suddenly changes.

It is preferred that the engaging transmission section of the tooth bottom of the concave portion of the belt wheel is connected to the friction transmission section on two sides by arc transition. The friction transmission section and the convex portion of the belt wheel are connected by arc transition. All sections use arc transitions for good connection stability and raising the transmission efficiency.

It is preferred that the concave and convex portions of the belt wheel are distributed uniformly in sequence.

Said concave and convex portions can be one selected from the group consisting of an involute gear, an elliptic gear, a hyperbolic gear, a parabolic gear and a cycloidal gear. It is preferred to be an arc gear.

It is preferred that the belt wheel is a multi-row joined combination. The belt groove of the small belt wheel is divided into 1 to 100 parallel sub-belt grooves along the axial direction of the belt wheel.

The beneficial effects of the present invention are that the bottom of the concave portion of the belt wheel is an engaging section, the concave and convex portions on the V-shaped belt are designed according to the engaging relationship to the engaging section, slipping is prevented by engaging transmission, meanwhile two sides of the engaging section use rolling friction section to prevent tooth gnawing, and the rolling friction makes the convex portion of the V-shaped belt enter the engaging section more easily to implement the engaging transmission. The composite transmission of the sliding friction transmission of the side surface of the V-shaped belt, the rolling friction transmission of the rolling friction section at a bottom of the wheel groove of the belt wheel and the engaging transmission of the engaging transmission section on the belt wheel increases the lifetime of the V-shaped belt, and at the same time, the transmission torque and the efficiency are increased and the tooth gnawing is ensured not to happen

### BRIEF DESCRIPTION OF THE DRAWINGS

FIG. 1 is a structural schematic view of a transmission belt and a belt wheel in use according to the present invention;

FIG. 2 is an enlarged front schematic view of a V-shaped belt wrapping on the belt wheel;

FIG. 3 is a front enlarged view taken on part D of FIG. 2;

FIG. 4 is a front enlarged view taken on part D of the belt wheel of FIG. 2;

FIG. 5 is a cross-section schematic view of the V-shaped belt in FIG. 1; and

FIG. 6 is a cross-section schematic view of the belt wheel in FIG. 2.

### DETAILED DESCRIPTION OF THE PREFERRED EMBODIMENT

Preferred embodiments of the present invention are given below with accompanying drawings for detailed description of the invention; however, these embodiments should not be regarded as limitation of the invention by any meaning.

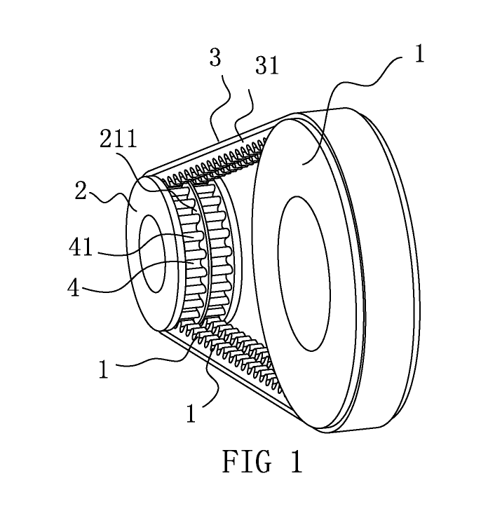

A preferred embodiment is a transmission belt of an oil pump for oil fields. For solving the slipping issue, as shown in FIG. 1, the small belt wheel 2 is designed to be toothed namely the belt wheel in the invention, while the big belt wheel 1 still remains the same shape. The force and torque transmitted by the small belt wheel are mainly transmitted by friction of the V surface, and the tooth designed on the small belt wheel has an auxiliary effect especially for preventing slipping. This is only one of the applications of the invention.

As shown in FIG. 6, the V-shaped transmission belts are five joined parallel V-shaped transmission belts, cooperating with the belt wheels of five joined parallel V-shaped belt groove.

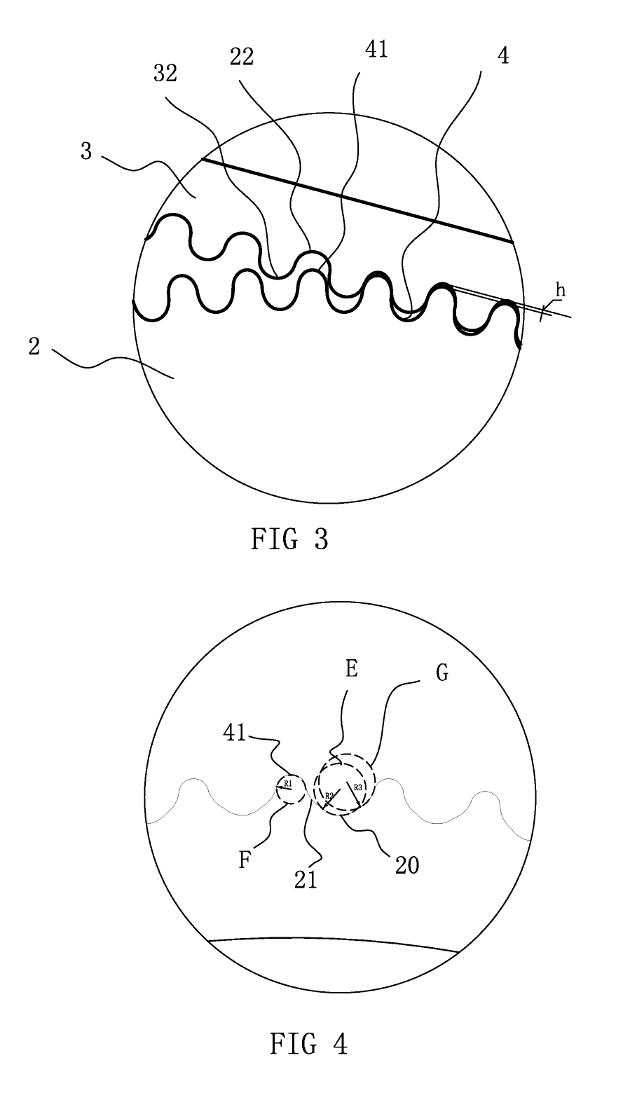

As shown in FIG. 1, the cross section of the V-shaped transmission belt 3 is V-shaped. Two side surfaces 31 of the V-shaped transmission belt 3 are in contact with two side walls 211 of the wheel groove of the belt wheel 2 for generating friction force. There are concave and convex portions formed on both the small belt wheel 2 and the transmission belt 3 according to the transmission principle on the inner diameter surface of the transmission belt 3, for example, a small belt wheel convex portion 41, a small belt wheel concave portion 4, a transmission belt convex portion 32 and a transmission belt concave portion 22. Sizes of the concave portions and the convex portions can be the same. The convex portion 32 of the transmission belt 3 engages with the engaging transmission section 20 on the groove bottom of the concave portion 4 of the small belt wheel 2. As shown in FIG. 3, a gap h is formed between the concave portion 22 of the transmission belt 3 and the convex portion 41 on the small belt wheel 2.

With reference to FIGS. 1, 3 and 4, the belt wheel 3 cooperates with the V-shaped belt 2 has a V-shaped groove 23 on it. The concave and convex portions 4, 41 are disposed on the bottom of the groove 23 of the belt wheel 2, wherein the bottom of the concave portion 4 is provided with a curve designed according to the engaging transmission principle as an engaging transmission section 20. A curve with a greater curvature is disposed symmetrically on two sides of the engaging section 20 as a rolling friction transmission section 21. The curvature radius of the rolling friction transmission section 21 is greater than the curvature radius of the engaging transmission section 20. The curvature radius of the convex portion 41 is smaller than the curvature radius of the engaging transmission section 20. Each section of the concave and convex portions is connected by arc transitions.

The ratio between curve heights of the engaging transmission section 20 on the belt wheel 2 and the rolling friction transmission section 21 is 1:2.5. The convex portion 32 on the inner bottom surface of the V-shaped belt 3 engages with the engaging transmission section 20 on the bottom of the concave portion of the belt wheel 2 for transmission. The shape of the concave portion 22 on the inner bottom surface of the V-shaped belt 3 and the shape of the convex portion 32 on the inner bottom surface of the V-shaped belt 3 are the same. A gap is maintained between the top of the convex portion 41 of the small belt wheel 2 and the bottom of the concave portion 22 of the V-shaped belt. The distance h of the gap is 0.72 mm. The height of the engaging transmission section 20 on the small belt wheel is 1.4 mm. The radius of the convex portion of the V-shaped belt is R. R is 2.95 mm.

As shown in FIG. 4, the dashed circle E indicates the arc of the engaging transmission section 20 and the radius thereof is R2. The dashed circle F indicates the arc on the convex portion 41 of the belt wheel and the radius thereof is R1. The dashed circle G indicates the arc of rolling friction transmission section of the belt wheel and the radius thereof is R3, and R1<R2<R3. The rolling friction transmission section 21 is an involute, and the rolling friction transmission sections 21 are disposed symmetrically on two sides of the engaging transmission section 20. The curvature radius of the convex portion 41 of the belt wheel is 1.69 mm. The curvature radius of the engaging transmission section 20 on the belt wheel is 2.95 mm. Because the curvature radius of the rolling friction transmission section 21 is different from the curvature radius of the engaging transmission section 20, namely the curvature radius of the rolling friction transmission section 21 is different from the curvature radius of the convex portion 32 of the V-shaped belt 3, the rolling friction transmission section 21 and the convex portion 32 of the V-shaped belt 3 generate the rolling friction.

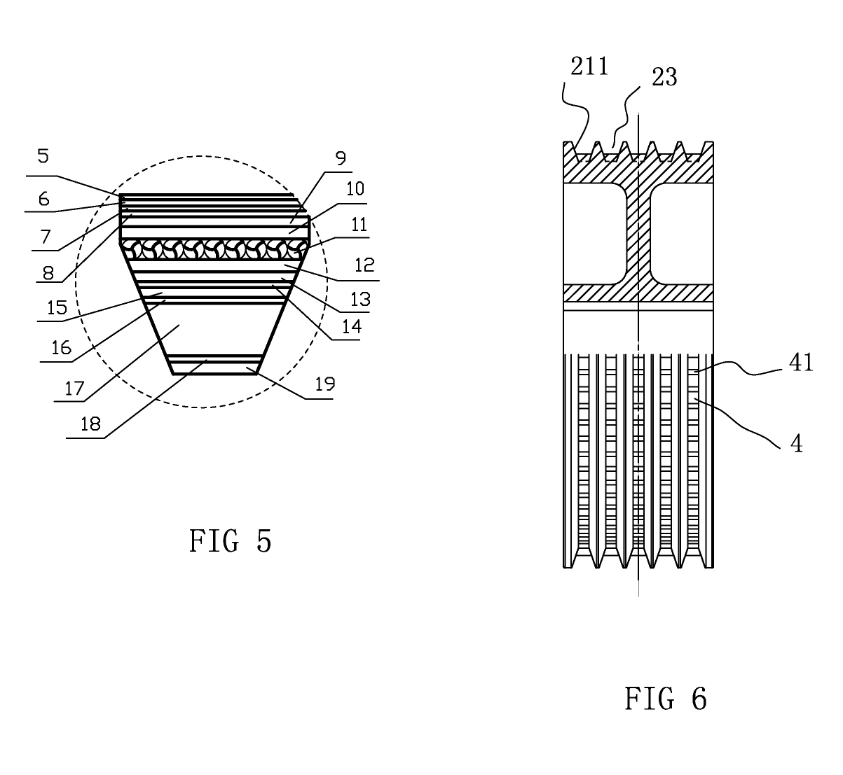

As shown in FIG. 5, a belt structure of the V-shaped belt 3 comprises a cotton rope layer 11. The top of the cotton rope layer 11 is composed of a buffering glue layer 10, a curtain cloth layer 9, a buffering glue layer 8, a twilled cloth layer 7, a buffering glue layer 6 and a twilled cloth layer 5 adhered to each other in sequence. The bottom of the cotton rope layer 11 is composed of a buffering glue layer 12, a fiber glue layer 13, a buffering glue layer 14, a curtain cloth layer 15, a buffering glue layer 16, a fiber glue layer 17 and a buffering glue layer 18 adhered to each other in sequence. An elastic cloth layer 19 is disposed on the surface of the concave and convex portions of the transmission belt 1. For carrying greater loading, the big belt wheel, the small belt wheel and the V-shaped belt can be multiplied and connectedly joined in parallel. The belt grooves of the big belt wheel and the small belt wheel in the invention are composed of two V-shaped belt grooves 23 joined in parallel, and two rows of belt body matching the groove body are also disposed on the V-shaped belt correspondingly. Certainly, as shown in FIG. 6, there can be five rows connected as a joined combination, and there are five belt grooves 23 on the belt wheel. The side surface 211 of the belt groove 23 has a friction transmission when cooperating with the V-shaped belt.

The invention is applied to an oil pump. Because the small belt wheel 2 is the driving wheel and the big belt wheel 1 is the driven wheel, the movement of the big belt wheel 1 only needs the driving by rolling friction of the V-shaped belt 3. The V-shaped belt 3 is provided with greater friction force to provide greater dragging force, which is suitable for use for large loading and torque. Because the wrapping angle of the small belt wheel 2 is smaller, during the operation process of the V-shaped belt 3, elastic deformation and elastic slipping easily occur and result in slipping behavior and then the lifetime of the V-shaped belt 3 is reduced. For preventing slipping behavior and reducing the elastic deformation and elastic slipping of the V-shaped belt 3, the engaging section 20 is designed on the V-shaped belt 3 and the small belt wheel 2, and the engaging transmission is implemented through the engaging section 20. For the belt tooth of the V-shaped belt to enter and withdraw more smoothly, a rolling friction transmission section 21 is designed on two sides of the engaging section 20. The rolling friction transmission of the side surface 211 of the small belt wheel 2, the rolling friction transmission of the rolling friction transmission section 21 and the engaging transmission of the engagement with the V-shaped belt 3 together implement the transmission cooperation between the small belt wheel and the V-shaped belt. Besides ensuring a larger transmission torque, there is still not any tooth gnawing and the lifetime of the belt is increased.

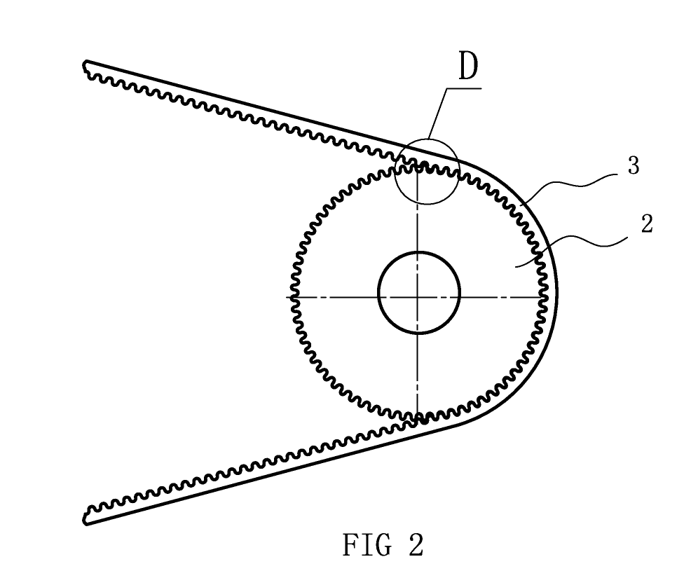

With reference to FIGS. 1-6, a V-shaped transmission belt 3 cooperates with a belt wheel 2 having a V-shaped wheel groove 23, wherein, a convex portion 32 and a concave portion 22 designed according to an engaging transmission principle are disposed on the inner diameter surface of the transmission belt. The shape and size of the concave portion 22 and the convex portion 32 are the same. The convex portion 32 engages with an engaging transmission section 20 on groove bottom of the concave portion 4 on the belt wheel 2. A gap is formed between the concave portion 22 of the belt 3 and the convex portion 41 on the belt wheel 2.

Two side surfaces 31 of the V-shaped transmission belt 3 are in contact with two side walls 211 of the wheel groove 23 to generate a friction force. In one embodiment, when operating normally, the shape of a convex portion 32 on the V-shaped transmission belt 3 is the same as the shape of a concaved engaging section 20 on the belt wheel 2. The convex portion 32 on the inner diameter surface of the V-shaped transmission belt 3 engages with the concaved engaging section 20 on the belt wheel 2 for transmission. When the loading suddenly changes or is overloaded, the convex portion 32 of the inner diameter surface of the V-shaped transmission belt 3 have a rolling friction or slipping friction with a curved section 21 on two sides of the concaved engaging section 20 on the belt wheel 2.

In one embodiment, a gap h is formed between the top of the convex portion 41 of said small belt wheel 2 and the groove bottom of the concave portion 22 of said V-shaped belt 3. The radius of the convex portion 32 of said V-shaped belt 3 is R, and 0.2 mm≦h<R. The gap size is determined according to the belt wheel size, mainly to ensure a sufficient heat-dissipating gap is maintained and to raise the heat-dissipating efficiency.

In one embodiment, the concave and convex portions 22, 32 of said transmission belt 3 are spaced at intervals in sequence and distributed uniformly. The concave portion 22 of the transmission belt 3 includes of a concave toothed part and the convex portion 32 includes a convex toothed part, and the concave and convex portions 22, 32 on the transmission belt 3 connect with each other and are distributed uniformly.

In one embodiment, the concave and convex portions 22, 32 of said transmission belt 3 are arc gear, or are selected from a group consisting of an involute gear, an elliptic gear, a hyperbolic gear, a parabolic gear and a cycloidal gear. In one embodiment, the concave and convex portions of the transmission belt are arc gear. The arc gear helps achieve excellent engaging transmission efficiency.

In one embodiment, the transmission belt 3 is a multi-row joined combination. The inner bottom surface of the V-shaped belt 3 is divided into 1 to 100 parallel sub-V-shaped belts along the axial direction. The number of the multi-row joined combination on the transmission belt 3 changes according to usage demands or shape sizes.

In one embodiment, the belt wheel 2 cooperates with a V-shaped transmission belt 3. Concave and convex portions 4, 41 are disposed along circumference and at bottom of a V-shaped wheel groove 23. A curve designed according to an engaging transmission principle is disposed on the bottom of the concave portion 4 as an engaging transmission section 20. A curved section with a larger curvature is disposed symmetrically on two sides of the engaging section 20 as a rolling friction transmission section 21. The curvature radius of the rolling friction transmission section 21 is greater than the curvature radius of the engaging transmission section 20. The curvature radius of the convex portion 41 is smaller than the curvature radius of the engaging transmission section 20.

Two side walls 211 of the V-shaped wheel groove 23 of the belt wheel 2 are in contact with two side surfaces 31 of the V-shaped transmission belt 3 to generate a friction force. When operating normally, the concaved engaging section on the belt wheel 2 engages with the convex portion 32 on the inner diameter surface of the V-shaped transmission belt 3 for transmission. When the loading changes suddenly or is overloaded, the curved section with the larger curvature disposed on two sides of the concaved engaging section 20 on the belt wheel 2 has a rolling friction with the convex portion 32 of the inner diameter surface of the V-shaped transmission belt 3.

The toothed parts of the concave and convex portions 4, 41 on the belt wheel 2 are connected by curves of three curvature radii. The curvature radius of the convex portion 41 on the belt wheel 2 is the smallest. The concave portion 22 and the convex portion 32 on the V-shaped belt 3 are the same, and both are designed according to the engaging principle, that is to say, the curvature radius of the convex portion 41 on the belt wheel 2 is smaller than the curvature radius of the concave portion 4 on the belt wheel 2, so that there is a gap maintained between the convex portion 41 of the belt wheel 2 and the concave portion 22 on the V-shaped belt 3 for heat dissipation and for reducing bending and constraint of the belt 3. The curvature radius of the rolling friction transmission section 21 is the largest, for ensuring the convex portion 32 of the V-shaped belt 3 with elastic deformation can enter the concave portion 4 of the belt wheel 2 and generate engaging transmission without tearing the belt tooth when the belt wheel 2 contacts with the V-shaped belt 3.

The belt wheel 2 of the V-shaped belt 3 as designed above can cooperate with the V-shaped belt 3 very well. Two side surfaces 31 of the belt 3 and two side surface 211 of the belt wheel 2 are in a slipping friction transmission status. The convex portion 32 of the V-shaped belt 3 and the belt wheel 2 are in an engaging transmission status at the engaging section 20. When the transmission is overloaded or the loading suddenly changes, the V-shaped belt 3 and the small belt wheel 2 are in the rolling friction transmission status again, and even the belt tooth can climb the convex portion of the wheel tooth to the maximum degree and further reenter the engaging section 20 for engaging transmission through the rolling friction transmission section 21. Such combined transmission system including slipping friction transmission, engaging transmission and rolling friction transmission solves the slipping issue of the small belt wheel 2 effectively, and at the same time effectively solves the difficult problem that the engaging transmission cannot perform overload protection. Because the belt tooth and the wheel tooth operate by rolling, the conventional slipping friction is changed into the rolling friction, so as the friction coefficient is greatly reduced, the belt operating lifetime is greatly increased, and the friction power loss is reduced such that the belt has the energy saving effect.

The curve height of said engaging section 20 is smaller than the belt tooth radius of the belt 3 engaging with the belt wheel 2. The engaging depth of them is designed to be smaller than the belt tooth radius. However, when the loading changes suddenly or is overloaded, the belt tooth is allowed to easily withdraw from engaging transmission at the rolling friction transmission section in the concave portion 4 of the belt wheel 2 and enter the rolling friction transmission status, and this rolling friction transmission proceeds by being constrained by the curve designed between the engaging transmission section 20 of the belt wheel 2 and the convex portion 32 of the V-shaped belt 3. Therefore, the design of the present invention not only ensures the accuracy of engaging transmission, but also implements protection to the belt 3 when overloading or the loading suddenly changes.

In one embodiment, the engaging transmission section 20 of the tooth bottom of the concave portion 4 of the belt wheel 2 is connected to the friction transmission section 21 on two sides by arc transition. The friction transmission section 21 and the convex portion 41 of the belt wheel 2 are connected by arc transition. All sections use arc transitions for good connection stability and raising the transmission efficiency.

In one embodiment, the concave and convex portions 4, 41 of the belt wheel 2 are distributed uniformly in sequence.

Said concave and convex portions 4, 41 can be one selected from the group consisting of an involute gear, an elliptic gear, a hyperbolic gear, a parabolic gear and a cycloidal gear. It is preferred to be an arc gear.

In one embodiment, the belt wheel is a multi-row joined combination. The belt groove of the small belt wheel 2 is divided into 1 to 100 parallel sub-belt grooves along the axial direction of the belt wheel 2.

A beneficial effects of the present invention are that the bottom of the concave portion 4 of the belt wheel 2 is an engaging section 20, the concave and convex portions 22, 32 on the V-shaped belt 3 are designed according to the engaging relationship to the engaging section 20, slipping is prevented by engaging transmission, meanwhile two sides 211 of the engaging section use rolling friction section to prevent tooth gnawing, and the rolling friction makes the convex portion 32 of the V-shaped belt 3 enter the engaging section 20 more easily to implement the engaging transmission. The combined transmission of the sliding friction transmission of the side surface 31 of the V-shaped belt 3, the rolling friction transmission of the rolling friction section 21 at a bottom of the wheel groove 23 of the belt wheel 2 and the engaging transmission of the engaging transmission section 20 on the belt wheel 2 increases the lifetime of the V-shaped belt, and at the same time, the transmission torque and the efficiency are increased and the tooth gnawing is ensured not to occur.

What is claimed is:

1. A V-shaped transmission belt, comprising:
a V-shaped transmission belt including an inner surface having concave teeth and convex teeth positioned alternately along a longitudinal direction of the V-shaped transmission belt, and two side surfaces positioned adjacent the inner surface along the longitudinal direction,
the V-shaped transmission belt cooperating with a belt wheel with a V-shaped wheel groove; the concave teeth and convex teeth having identical shape and size, each convex tooth engaging with an engaging transmission section on a concave tooth on the belt wheel, a gap being maintained between each concave tooth on the V-shaped transmission belt and a corresponding convex tooth on the belt wheel; and
the two side surfaces of the V-shaped transmission belt contacting with two side walls of the wheel groove of the belt wheel to generate a friction force, the shape of a convex tooth of the V-shaped transmission belt being identical to the shape of a concaved engaging transmission section on the belt wheel,
during normal operation, the convex tooth on the V-shaped transmission belt engaging with the corresponding concaved engaging transmission section on the belt wheel for transmission,
when the belt is overloaded, the convex tooth on the V-shaped transmission belt having a rolling friction or slipping friction transmission with a curved section adjacent the concaved engaging transmission section of the belt wheel.

2. The V-shaped transmission belt as claimed in claim 1, wherein a gap h is maintained between top of a convex tooth of said belt wheel and bottom of a corresponding concave tooth of said V-shaped transmission belt, and the radius of the convex tooth of said V-shaped transmission belt is R, and 0.2 mm≦h<R.

3. The V-shaped transmission belt as claimed in claim 1, wherein concave-convex teeth of said V-shaped transmission belt are spaced at intervals in sequence and distributed uniformly, and the concave-convex teeth of said transmission belt are selected from a group consisting of an arc gear, an involute gear, an elliptic gear, a hyperbolic gear, a parabolic gear and a cycloidal gear.

4. The V-shaped transmission belt as claimed in claim 1, wherein a belt structure of said V-shaped transmission belt comprises a cotton rope layer, and a top of the cotton rope layer is composed of a buffering glue layer, a curtain cloth layer, a buffering glue layer, a twilled cloth layer, a buffering glue layer and a twilled cloth layer adhered to each other in sequence, and a bottom of the cotton rope layer is composed of a buffering glue layer, a fiber glue layer, a buffering glue layer, a curtain cloth layer, a buffering glue layer, a fiber glue layer and a buffering glue layer adhered to each other in sequence, and an elastic cloth layer is disposed on a surface of the concave and convex teeth of said transmission belt.

5. The V-shaped transmission belt as claimed in claim 1, wherein the V-shaped transmission belt is a multi-row joined combination, and an inner bottom surface of the V-shaped transmission belt is divided into 1 to 100 parallel sub V-shaped belts along an axial direction.

6. A belt wheel, comprising:
a belt wheel with a V-shaped wheel groove cooperating with a V-shaped transmission belt, concave-convex teeth being disposed at a bottom of a V-shaped wheel groove, wherein a first curve section is disposed on a bottom of each concave tooth as an engaging transmission section, a curved section with a larger curvature is disposed symmetrically on two sides of the engaging transmission section and adjacent the engaging section as a rolling friction transmission section, a curvature radius of the rolling friction transmission section is greater than a curvature radius of the engaging transmission section, a curvature radius of the convex tooth is smaller than a curvature radius of the engaging transmission section; and
two side walls of the V-shaped wheel groove of the belt wheel contacting with two side surfaces of the V-shaped transmission belt to generate a friction force,
during normal operation, the concaved engaging transmission section on the belt wheel engaging with a corresponding convex tooth of the V-shaped transmission belt for transmission,
when the belt wheel is overloaded, a rolling friction transmission section adjacent the concaved engaging transmission section on the belt wheel having a rolling friction or a slipping friction transmission with the corresponding convex tooth of the V-shaped transmission belt.

7. The belt wheel as claimed in claim 6, wherein a curve height of said engaging transmission section is smaller than a radius of a belt tooth of the V-shaped transmission belt engaging with the belt wheel.

8. The belt wheel as claimed in claim 6, wherein the engaging transmission section of the bottom of the concave tooth of the belt wheel is connected to an adjacent rolling friction transmission section positioned on each side thereof by arc transition, and the rolling friction transmission section and an adjacent convex tooth of the belt wheel are connected by arc transition.

9. The belt wheel as claimed in claim 6, wherein the concave and convex teeth of the belt wheel are distributed uniformly in sequence, and the concave and convex teeth are selected from a group consisting of an arc gear, an involute gear, an elliptic gear, a hyperbolic gear, a parabolic gear and a cycloidal gear.

10. The belt wheel as claimed in claim 6, wherein the V-shaped wheel groove is divided into 1 to 100 parallel sub grooves along an axial direction of the belt wheel.

11. A transmission system, comprising:
the transmission belt including first concave teeth identical to each other and first convex teeth identical to each other, the concave teeth and convex teeth being disposed along a longitudinal direction of the transmission belt and positioned alternately, the first concave and convex teeth having identical shape and size, with a radius of R; and
the belt wheel including second concave teeth identical to each other and second convex teeth identical to each other, each convex tooth having a radius of R1, each concave tooth including an engaging section positioned on a bottom of the concave tooth and a friction section positioned between the engaging section and adjacent convex teeth, the engaging section having a radius of R2 and the friction section having a radius of R3,
the first concave and convex teeth are engagable with the second convex and concave teeth respectively, with a gap maintained between each first concave tooth and a corresponding second convex tooth,
during normal operation, movement of the belt wheel being transmitted to the transmission belt by sliding friction transmission between side walls of a groove of the belt wheel where the second concave and convex teeth are disposed and side surfaces of the transmission belt;
when the transmission system is overloaded, the movement is transmitted to the transmission belt by a rolling or sliding friction transmission between the friction section of the second concave tooth and a corresponding first convex tooth,
wherein R1<R2<R3.

12. A method for transmitting movement from a belt wheel to a transmission belt, comprising:
engaging the belt wheel with the transmission belt, wherein:
the transmission belt including first concave teeth identical to each other and first convex teeth identical to each other, the concave teeth and convex teeth being disposed along a longitudinal direction of the transmission belt and positioned alternately, the first concave and convex teeth having identical shape and size, with a radius of R,
the belt wheel including second concave teeth identical to each other and second convex teeth identical to each other, each convex tooth having a radius of R1, each concave tooth including an engaging section positioned on a bottom of the concave tooth and a friction section positioned between the engaging section and adjacent convex teeth, the engaging section having a radius of R2 and the friction section having a radius of R3, wherein R1<R2<R3;
during normal operation, transmitting the movement of the belt wheel to the transmission belt by sliding friction transmission between side walls of a groove of the belt wheel where the second concave and convex teeth are disposed and side surfaces of the transmission belt; and
when the transmission system is overloaded, transmitting the movement to the transmission belt by a rolling or sliding friction transmission between the friction section of the second concave tooth and a corresponding first convex tooth.
